(19) United States
(12) Patent Application Publication
(10) Pub. No.: US 2015/0296530 A1
(43) Pub. Date: Oct. 15, 2015

(54) METHOD FOR DOWNLINK TRAFFIC PRIORITY INDICATION

(71) Applicant: MEDIATEK INC., Hsin-Chu (TW)

(72) Inventors: Tianyu Wu, San Jose, CA (US); Jianhan Liu, San Jose, CA (US); Thomas Edward Pare, JR., Mountain View, CA (US)

(21) Appl. No.: 14/682,126

(22) Filed: Apr. 9, 2015

Related U.S. Application Data
(60) Provisional application No. 61/977,252, filed on Apr. 9, 2014.

(51) Int. Cl. H04W 72/12; H04W 52/02

(52) U.S. Cl. CPC H04W 72/1247; H04W 72/1289; H04W 72/1273; H04W 52/0216

(57) ABSTRACT

A method for downlink traffic priority indication is provided. A wireless device, such as an access point, receives signals destined to a first wireless station and a second wireless station. Since the first wireless station and the second wireless station are associated with the wireless device, the wireless device sends a notice signal to the first wireless station and the second wireless device to inform about the signals. The notice signal sent by the wireless device includes downlink priority information according to the signals such that the wireless stations can manage the downlink traffic accordingly.

### CROSS REFERENCE TO RELATED APPLICATIONS

This application claims priority under 35 U.S.C. §119 from U.S. Provisional Application No. 61/977,252, entitled “DL traffic priority indication,” filed on Apr. 9, 2014, the subject matter of which is incorporated herein by reference.

### BACKGROUND

The disclosed embodiments relate generally to wireless network communications, and, more particularly, to priority indication and channel contention for downlink traffic in wireless communications systems.

In a wireless communication system, such as a local area network (WLAN) that complies with IEEE 802.11 standard, a plurality of wireless stations (STAs) are associated with another wireless device, such as an access point (AP) or another station working in access point mode. If the AP receives packets that are destined to any of the associated STAs, the AP informs the STAs that there will be downlink (DL) traffic from the AP to the STA by adding information into a notice signal, such as beacons. Therefore, the corresponding positions in the partial virtual bitmap in the beacon of the STAs with DL traffic are set to 1 to indicate the DL traffic, as shown in FIG. 1. However, the STAs that receive the beacons only know there will be DL traffic but there isn't any mechanism for the AP or the STAs to identify the priorities for each of the DL traffic. The STA that needs to receive an important DL traffic might suffer delay due to lack of priority information. Hence, there's a need to provide a method to indicate the priorities of the DL traffics.

### SUMMARY

It is therefore an object of the present invention to provide a method for downlink priority indication. The method comprising, receiving signals destined to a first wireless station and a second wireless station by a wireless device. The wireless device then sends a notice signal to the first wireless station and the second wireless device to inform about the signals, wherein the notice signal includes a downlink priority information according to the signals.

According to an embodiment of the present invention, the notice signal is a beacon or a separate packet other than a beacon.

According to yet another embodiment of the present invention, the notice signal includes the association identifiers for the first wireless station and the second wireless station. And the downlink priority indication information may comprise a downlink priority indication for each of the association identifiers.

### BRIEF DESCRIPTION OF THE DRAWINGS

FIG. 1 illustrates a conventional traffic indication map.

FIG. 2 illustrates a wireless network communications system according to an embodiment of the present invention.

3A˜3E illustrate examples of downlink priority indication according to embodiments of the present invention.

FIG. 4 illustrates a PS-POLL frame according to an embodiment of the present invention.

FIG. 5 illustrates an intended RDG according to an embodiment of the present invention.

### DETAILED DESCRIPTION

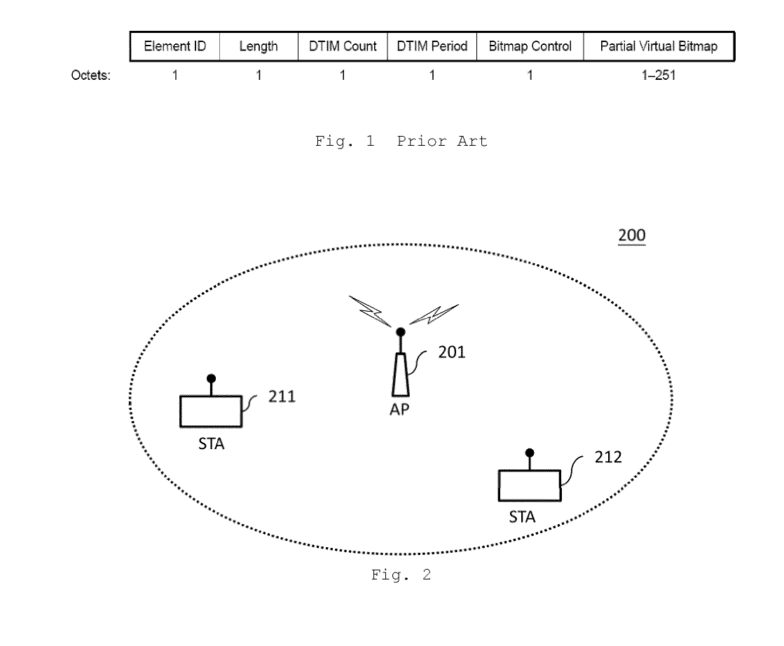

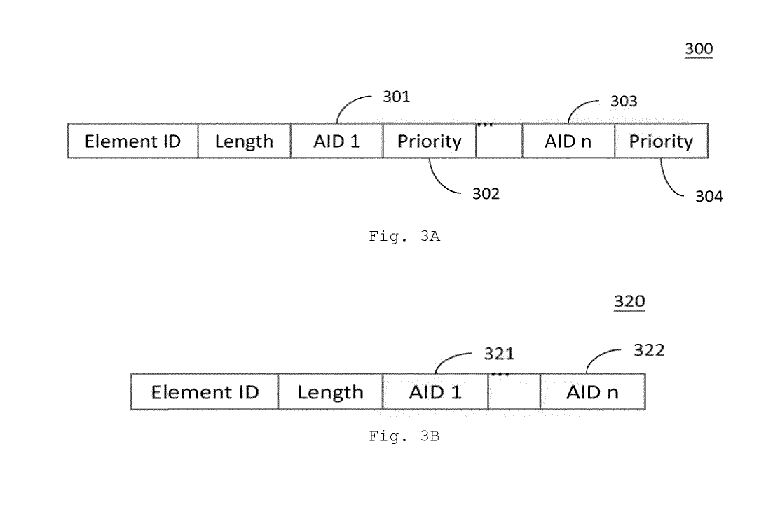

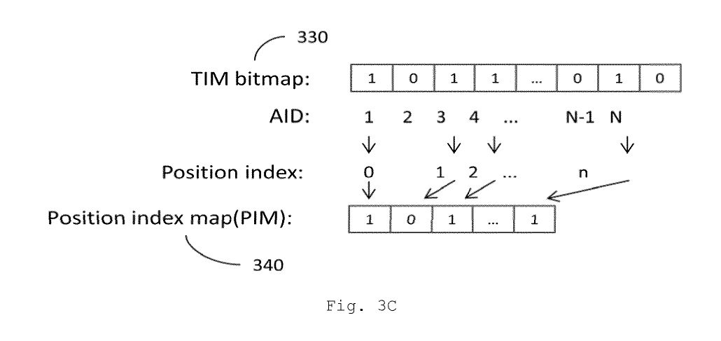

Please refer to FIG. 2, which illustrates a wireless network communications system 200 according to an example of the present invention. A plurality of stations (STAs), for example STAs 211 and 212, are associated with an access point (AP) 201. The AP 201 communicates with the STAs 211 and 212 with uplink (UL) and downlink (DL) traffics. When the AP 201 receives packets that need to be forwarded to the STAs 211 or 212 from the backbone network, the AP 201 informs the STAs 211 and 212 about the packets by adding an indication to the beacons sent to the STAs . According to an embodiment of the present invention, a downlink priority indication (DPI) used to identify the priorities of the packets is further used to inform the STAs about the priorities of the packets. The downlink priority indication (DPI) can be sent to the STAs in several ways. For example, the DPI can be sent with the beacon by adding an additional information element (IE) to the beacon or using reserved or redundant bits in the beacon. The downlink priority indication (DPI) can be sent in a separate packet other than the beacon alternatively.

FIG. 3A illustrates a modified beacon 300 according to an embodiment of the present invention that transmits the downlink priority indication (DPI) by adding an additional IE to the beacon. The modified beacon 300 sent from an AP includes the association identifiers (AID) , such as AID1 301 and AIDn 303 in FIG. 3A, which indicate the associated STAs that have DL traffic, while each AID has a DPI Priority 302 and 304 after AID1 and AIDn, respectively. Hence, DPI 302 indicates the priority of AID1 301, while DPI 304 indicates the priority of AIDn 303. Therefore, the STAs with the corresponding AID get the priority information when the STAs receive the modified beacon, and can therefore use the priority information to manage the DL traffic between the STAs and the AP.

The modified beacon shown in FIG. 3A is suitable when only a small number of STAs are associated with the AP. When the number of STAs associated with the AP increases, the overhead will become too heavy. Therefore, FIG. 3B illustrates an alternative method. When the STAs associate with the AP, the AP and the STAs setup criteria that define the priorities of the packets, for example by defining different priorities for packets with voice and video. Therefore, when the AP receives packets that are destined to the associated STAs, the AP only lists the AIDs that fulfill the priority criteria in the beacon. As shown in FIG. 3B, the modified beacon 320 only includes the AIDs of the STAs that meet the criteria setup by the AP and the STA, such as AID1 321 and AIDn 322. The STAs can therefore know the priority of the DL traffic that is destined to them. The overhead of the beacon with DPI can therefore be reduced.

FIG. 3C further provides another alternative of sending the priority for a list of STAs with lower overhead. Within the TIM (traffic indication map) element, shown in FIG. 1, of a beacon, there's a partial virtual bitmap (PVB) field included therein. This TIM bitmap 330 is again shown in FIG. 3C. This field is used to mark which associated STA has downlink traffic by assigning “1” in the corresponding positions of the STA in the PVB field. In other word, only the STAs that are indicated by “1” in the corresponding positions in the PVB field need to provide a priority indication. In the example given in FIG. 3C, only STAs with AID 1, 3, 4, . . . , N−1 have DL traffic and need to be assigned with a DPI. The positions in the TIM element showing the STAs with downlink traffic are further transferred into position indices shown in FIG. 3C. After that, an IE including a position index map (PIM) 340 can be generated according to the position indices, and the PIM includes the priority indication for each STA that have downlink traffic. According to the example in FIG. 3C, the STA with AID 1 has DL traffic, and is then assigned a position index “0”, and the DL traffic to the STA with the AID 1 has a priority indication of “1”, which may be used to indicate a high priority. On the other hand, the STA with an AID 3 also has downlink traffic, and is then assigned a position index “1”, and the DL traffic to the STA with the AID 3 has a priority indication of “0”, which may be used to indicate a low priority. Since the STA with an AID 2 does not have DL traffic at this moment and is therefore skipped when assigning a position index. This may apply to all the STAs that have downlink traffic. Therefore, when the STAs receive the position index map, the STAs can get the priority information of the downlink traffic destined to it.

The method mentioned in FIG. 3C can be further improved in combination with priority criteria. For example, please refer to FIG. 3D, the STAs that fulfill a predetermined priority criteria can be assigned with “1”s in the PIM 340 to indicate the STAs with downlink traffic fulfill the priority criteria. To further indicate priority for selected STAs, a priority field 341, 342, can be added in the PIM. Therefore, if a “1” is detected in the PIM with priority indication, next K bits in the bitmap will indicate the DL traffic priority of the corresponding STA. And K is a predefined number of bits for priority indication. According to IEEE 802.11 spec, 1 byte (8 bits) are used for user priority.

In another example, to indicate the priority for all STAs with downlink traffic, the DPI can just list the priorities for STAs indicated by “1” in PVM in TIM element, as shown in FIG. 3E.

Another alternative to send the downlink priority indication (DPI) is to send a separate packet to identify the priority information. The separate packet can include the information shown in the previous examples, such as those shown in FIG. 3A , FIG. 3B , FIG. 3C and FIG. 3D. However, please note that the embodiments described herein are only exemplary and are not limited thereto. Any methods that can used to send the downlink priority indication to the STAs with DL traffic are within the scope of this invention.

With DPI assigned to the STAs, a number of performance enhancing mechanisms can be supported. For example, the wireless communications system performance for dense deployed scenarios can be improved. Also, better QoS for delay sensitive applications can be provided. The power efficiency for the wireless communications system can be improved as well.

The present invention can also be applied to dense deployment scenario, such as indoor small basic service set (BSS) hotspot and outdoor large BSS hotspot scenarios where 1 AP may need to support more than 100 STAs. Also, for widely applied EDCA protocol where AP and STA are equivalent during contention, AP may have difficulty to obtain the channel for DL traffic. QoS for DL traffic will be poor. And with the present invention by adding DPI in the beacon, STAs can help AP to contend for its own downlink data.

### Enhanced PS-POLL

In the scenario that the STA can aid channel contention, the STA can decide whether to contend the channel for its downlink data based on TIM and DPI information elements. If TIM indicates downlink data arrived for the STA and DPI shows the priority of the DL is high, the STA can initiate a channel contention for its DL data. And the STA can use the indicated priority for the channel contention. The contention can be initiated by a PS-POLL (power save poll) frame, null data packet (NDP) frame or other triggering frame. With the DPI, PS-POLL can be enhanced such that the STA can use the indicated priority to send the PS-POLL frame in addition to using AC_BE in the IEEE 802.11 standard. Besides, intended reverse direction grant (RDG) can be applied when STA does not have UL data. STA with high priority DL data can initiate an intended RDG and grand the channel to the AP for its DL traffic.

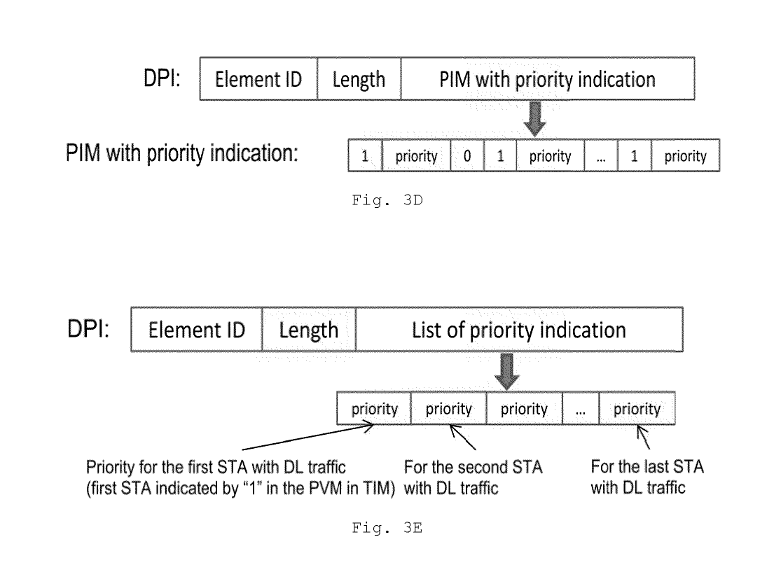

According to the present invention, an enhanced PS-POLL can be provided. However, with DPI, if the DL data for a STA has a priority of AC_VI (video) , the STA can send PS-POLL with priority AC_VI rather than the conventionally used AC_BE. Since there is no duration field in PS-POLL, conventionally, other STAs need to wait for the DL packet from AP to set their NAV before they can go to sleep. According to another example of the present invention, a new PS-POLL frame is provided, as shown in FIG. 4. Since the STA does not know the duration of the DL frame, the duration can be set to max TXOP length, while CF-END can be used to terminate the TXOP. The polling frame according to the present invention can be a polling for DL data from STA. A new frame sub-type can be assigned to this frame.

### Intended RDG

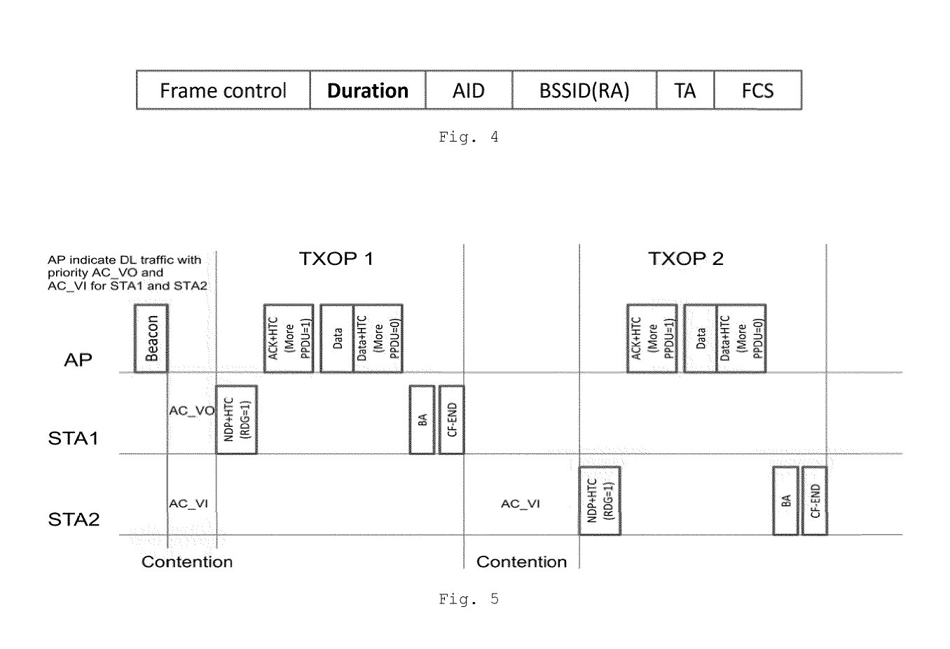

According to an embodiment of the present invention, STA with high priority DL data can initiate an intended RDG to contend the channel for AP with the help to DPI. Therefore, an STA without uplink traffic shall send a NULL packet to initiate the RDG. The indicated priority can be used for the initiating frame, as shown in FIG. 5.

### Improvement on Power Efficiency

According to an embodiment of the present invention, the STA may use the new information provided by DPI to improve the power efficiency. For example, if a STA is indicated in TIM (has DL data) but not indicated in DPI (no high priority data) , the STA may decide to go to sleep and not retrieve its DL data. The power sensitive STA can therefore wait until the next one or more beacons, or until there is high priority data for it, or until the length of the buffered data exceeds a threshold (if the length of buffered data is provided). With the present invention, less channel contentions are needed before the STA retrieves its DL data and therefore save power.

### Extension of the IE

Besides priority, more information can be provided in the beacon according to an embodiment of the present invention. For example, the length of the buffered data or the maximum delay of the buffered data can also be included in the beacon alone or in combination. By including more information in the beacon, the information can help the STA to tell how urgent the DL traffic is and to determine whether to contend the channel for DL traffic or not. Moreover, if the size of buffered data is large or the delay of buffered data is long, the STA should retrieve the DL packets from the AP based on the additional information in the beacon according to the present invention.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving signals destined to a first wireless station and a second wireless station by a wireless device; and
sending a notice signal to the first wireless station and the second wireless device to inform about the signals, wherein the notice signal includes a downlink priority information of the signals.

2. The method of claim 1, wherein the notice signal is a beacon.

3. The method of claim 1, wherein the notice signal includes association identifiers of the first wireless station and the second wireless station.

4. The method of claim 3, wherein the downlink priority information comprise a downlink priority indication for each of the association identifiers.

5. The method of claim 1, wherein the step of sending a notice signal comprises,
sending a beacon to the first wireless station and the second wireless device to inform about the signal; and
sending a packet to the first wireless station and the second wireless device to inform the downlink priority information according to the signals.

6. The method of claim 1, wherein the step of sending a notice signal comprises,
sending a traffic indication map to indicate which wireless station has a downlink traffic; and
generating a position index map according to the traffic indication map and the downlink priority information.

7. The method of claim 6, further comprising,
receiving signals by the first wireless station according to the position index map if a downlink priority information for the first wireless station is high.

8. The method of claim 6, further comprising,
setting the first wireless station to a sleep mode if a downlink priority information for the first wireless station is low.

9. The method of claim 1, wherein the notice signal further comprises a length of a buffered data or a maximum delay of the buffered data.

10. The method of claim 1, wherein the notice signal comprises a downlink priority indication only for the first wireless station if the received signal is only for the first wireless station.
